(19) United States
(12) Patent Application Publication
(10) Pub. No.: US 2010/0114581 A1
(43) Pub. Date: May 6, 2010

(54) Method for encoding, method for decoding, encoder, decoder and computer program products

(76) Inventors: Te Li, Singapore (SG); Susanto Rahardja, Singapore (SG)

Correspondence Address: CHOATE, HALL & STEWART LLP, TWO INTERNATIONAL PLACE, BOSTON, MA, 02110, US

(21) Appl. No.: 12/444,479

(22) PCT Filed: Oct. 5, 2007
(86) PCT No.: PCT/SG2007/000338

§ 371 Date: Jul. 2, 2009

Related U.S. Application Data
(60) Provisional application No. 60/828,434, filed on Oct. 6, 2006.

(51) Int. Cl. G10L 19/00

(52) U.S. Cl. 704/500

(57) ABSTRACT

A method for encoding a plurality of signal values is described, wherein the signal values are grouped into a first subgroup and a second subgroup, the signal values of the first subgroup are compared to the signal values of the second subgroup and based on the result of the comparison it is decided whether the signal values of the first subgroup are bit-plane encoded with higher priority than the signal values of the second subgroup.

The invention relates to a method for encoding a plurality of signal values, a method for decoding a plurality of encoded signal values, an encoder, a decoder and computer program products.

With the advances in computers, networking and communications, streaming audio contents over networks such as the Internet, wireless local area networks, home networks and commercial cellular phone systems is becoming a mainstream means of audio service delivery. It is believed that with the progress of the broadband network infrastructures, including xDSL, fiber optics, and broadband wireless access, bit-rates for these channels are quickly approaching those for delivering high sampling-rate, high amplitude resolution (e.g. 96 kHz, 24 bit/sample) lossless audio signals.

On the other hand, there are still application areas where high-compression digital audio formats, such as MPEG-4 AAC (Moving Pictures Expert Group; Advanced Audio Coding) are required. As a result, interoperable solutions that bridge the current channels and the rapidly emerging broadband channels are highly demanded. In addition, even when broadband channels are widely available and the bandwidth constraint is ultimately removed, a bit-rate-scalable coding system that is capable to produce a hierarchical bit-stream whose bit-rates can be dynamically changed during transmission is still highly favourable.

For (bit-rate-)scalable coding of audio data, video data or image data, the method of bit-plane coding is commonly used. In bit-plane coding an input data vector with a plurality of bit-planes is encoded according to a bit-plane representation of the data vector. A bit-plane comprises the bits of all components corresponding to one digit of the binary representation of the components. For example, the first bit-plane comprises all bits of the components of the most significant bit (Mth digit) of the binary representation of the components, the second bit-plane comprises all bits of the components of the M-1th digit of the binary representation of the components, and so on.

In bit-plane coding, the bit-plane representation is scanned in such way that a bit-stream is generated that comprises the bits of the components of the input data vector in the order from the most significant bits to the least significant bits of the components. The bit-stream also includes the sign bits of the components, usually preceding the most significant bits of the components.

The bit-stream generated in this way may be entropy coded, for example based on a properly assigned statistical model and then be transmitted to a receiver. The entropy encoded bit-stream may be decoded by a decoder provided in the receiver by reconstructing the signs and the bits of the components such that the original input vector is reconstructed.

An advantage of bit-plane coding is that the bit-stream may be truncated when the available data rate for transmitting the whole bit-stream is to low. The truncated bit-stream comprises the original bit-planes only partially but can still be decoded in the decoder to generate a coarse reconstruction of the original data vector, i.e. a lossy reconstruction of the original data vector. In this way, bit-plane coding provides a convenient way to generate codes which are scalable with a fine granularity.

The order in which the bit-planes are scanned is usually fixed for a particular coding scheme. For example, the bit-planes are scanned from the most significant bit-plane (i.e. from the bit-plane comprising the most significant bits) to the least significant bit-plane (i.e. to the bit-plane comprising the least significant bits).

A method for encoding a plurality of signal values is provided, wherein the signal values are grouped into a first subgroup and a second subgroup, wherein the signal values of the first subgroup are compared to the signal values of the second subgroup, wherein based on the result of the comparison it is decided whether the signal values of the first subgroup should be encoded with higher priority than the signal values of the second subgroup and wherein the signal values of the first subgroup and the signal values of the second subgroup are bit-plane coded wherein the signal values of the first subgroup are bit-plane coded with priority if it is decided that the signal values of the first subgroup should be encoded with higher priority than the signal values of the second subgroup.

Further, an encoder and a computer program product according to the method for encoding a plurality of signal values as described above are provided.

According to another embodiment of the invention, a method for decoding a plurality of encoded signal values is provided, comprising receiving the encoded signal values being bit-plane coded from a plurality of signal values, the signal values being grouped to a first subgroup and a second subgroup, determining whether the signal values of the first subgroup have been bit-plane coded with priority when the signal values have been encoded, and bit-plane decoding the encoded signal values taking into account whether the signal values of the first subgroup have been bit-plane coded with priority when the signal values have been encoded.

Further, a decoder and a computer program product according to the method for decoding a plurality of encoded signal values as described above are provided.

Illustratively, the signal values are analyzed before coding, for example the energy distribution in the signal values is analyzed and based on the result, the coding is performed, for example an efficient coding order is chosen in course of the bit-plane coding.

For example, each signal value corresponds to a frequency and the signal values of the first subgroup correspond to a low frequency region and the signal values of the second subgroup correspond to a high frequency region and it is determined whether the energy of the signal corresponding to the signal values is concentrated in the signal values of the first subgroup.

An idea on which one embodiment of the invention is based can be seen in that it has been realized that when the energy of a signal is concentrated in the low frequency region, like it is often the case for audio signals or video signals, it is reasonable to assign high priority to the low frequency region when bit-plane coding, for example, scan parts of the bit-planes corresponding to low frequency coefficients first.

In one embodiment, based on the result of the comparison, it is chosen between a first bit-plane encoding scheme and a second bit-plane encoding scheme. For example, according to the first bit-plane encoding scheme the signal values of the first subgroup are bit-plane encoded with priority and according to the second bit-plane encoding scheme, the signal values of the first subgroup and the signal values of the second subgroup are bit-plane encoded with same priority.

By switching between two bit-plane encoding schemes, for example for each frame of a data signal to be encoded and for example based on the energy distribution of the data signal in the frequency spectrum, bit-plane encoding can be performed in a more efficient manner.

It can be verified by simulation that the perceptual quality of audio at intermediate bit-rates can be improved by a significant amount in terms of ODG (Objective Difference Grade) measurements using the invention compared to original SLS (Scalable Lossless Coding) for most audio sequences with unbalanced energy distribution in the frequency domain. This can be achieved by only introducing negligible overhead in terms of computational complexity or lossless coding efficiency.

Embodiments of the invention emerge from the dependent claims. The embodiments which are described in the context of the method for encoding are analogously valid for the encoder, the method for decoding, the decoder and the computer program products.

In one embodiment, each signal value corresponds to a frequency. For example, the first subgroup comprises all signal values corresponding to frequencies of a first frequency region and the second subgroup comprises all signal values corresponding to frequencies of a second frequency region. The frequencies of the first frequency region are for example lower than the frequencies of the second frequency region. This means that for example, the frequencies are divided into a low frequency region and a high frequency region.

It is to be noted that the signal values may also be grouped into more than two subgroups and that it may be decided that one or more of the subgroups should be bit-plane coded with priority. For example, based on a comparison of the signal values of the subgroups, each subgroup may be associated with a coding priority and the subgroups may be bit-plane coded taking into account the priorities.

Each signal value is for example an error signal value specifying an error (for example the difference) between a first frequency coefficient and a second frequency coefficient for the frequency the signal value corresponds to.

In one embodiment, the first frequency coefficient corresponds to a lossy frequency domain representation of a data signal and the second frequency coefficient corresponds to a lossless frequency domain representation of the data signal.

The data signal may be an audio data signal, a video data signal or a still image data signal.

If it is decided that the signal values of the first subgroup should be encoded with higher priority than the signal values of the second subgroup, the signal values of the first subgroup are for example at least partially bit-plane coded before the signal values of the second subgroup are bit-plane coded. For example, a plurality of bit-planes of the signal values of the first subgroup are scanned before any bit-planes of the signal values of the second subgroup are scanned. This means that the bits of the plurality of bit-planes of the signal values of the first subgroup will precede the bits of the bit-planes of the signal values of the second subgroup in the resulting bit-stream.

If it is decided that the signal values of the first subgroup should not be encoded with higher priority than the signal values of the second subgroup the signal values of the first subgroup and the signal values of the second subgroup are for example bit-plane coded with same priority. This means that “normal” bit-plane coding, for example the bit-plane coding scheme used according to MPEG-4 audio Scalable Lossless Coding (SLS), is used when it is decided that the signal values of the first subgroup should not be encoded with higher priority than the signal values of the second subgroup.

In one embodiment, a comparison value is determined based on the comparison of the signal values of the first subgroup to the signal values of the second subgroup and wherein based on the size of the comparison value the priority level with which the signal values of the first subgroup should be encoded is determined.

For example, a plurality of value ranges are predetermined, each value range is associated with a priority level and the priority level with which the signal values of the first subgroup should be encoded is determined as the priority level associated with the value range in which the comparison value is located.

This provides a simple method for determining the priority level which can be implemented with low complexity.

The comparison value may be calculated based on an energy measure of the signal values of the first subgroup and the second subgroup.

In one embodiment, the first subgroup comprises all signal values corresponding to frequencies of a first frequency region and the second subgroup comprises all signal values corresponding to frequencies of a second frequency region and a third frequency region, wherein the frequencies of the first frequency region are lower than the frequencies of the second frequency region and the frequencies of the second frequency region are lower than the frequencies of the third frequency region and, when it is decided that the signal values of the first subgroup should be encoded with higher priority than the signal values of the second subgroup, the signal values corresponding to frequencies of the second frequency region are also encoded with higher priority than the signal values corresponding to frequencies of the third frequency region.

Illustrative embodiments of the invention are explained below with reference to the drawings.

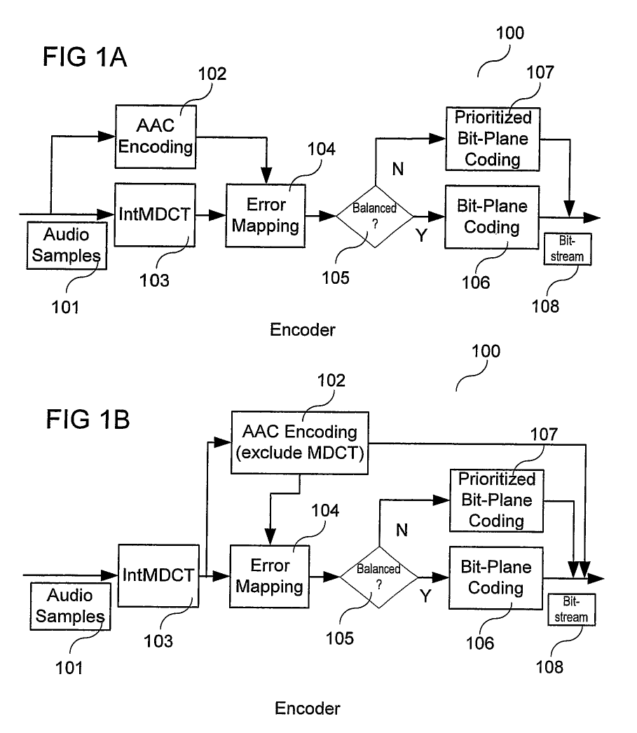

FIG. 1a and FIG. 1b each shows an encoder according to an embodiment of the invention.

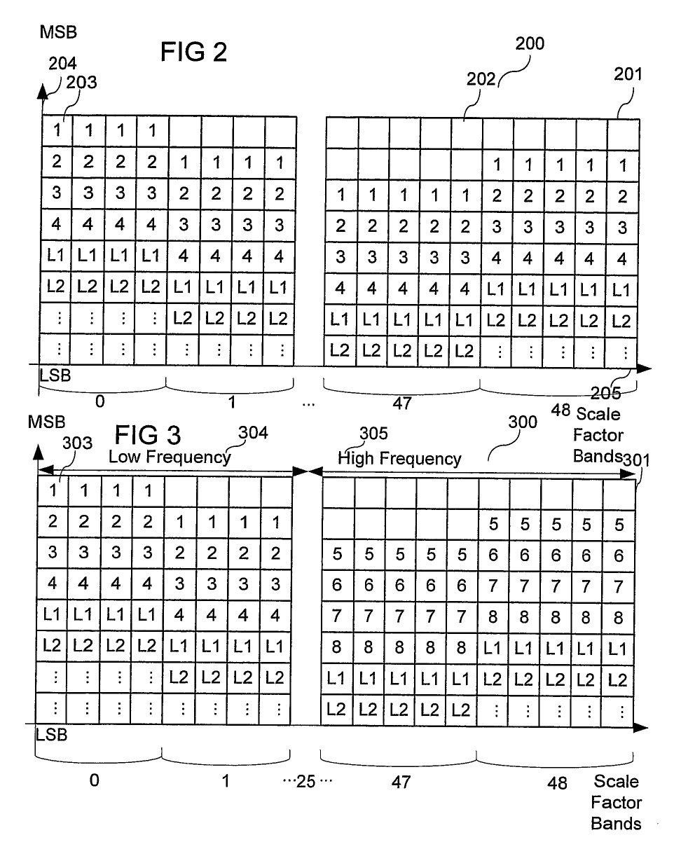

FIG. 2 shows a representation of error signal values according to an embodiment of the invention.

FIG. 3 shows a representation of error signal values according to an embodiment of the invention.

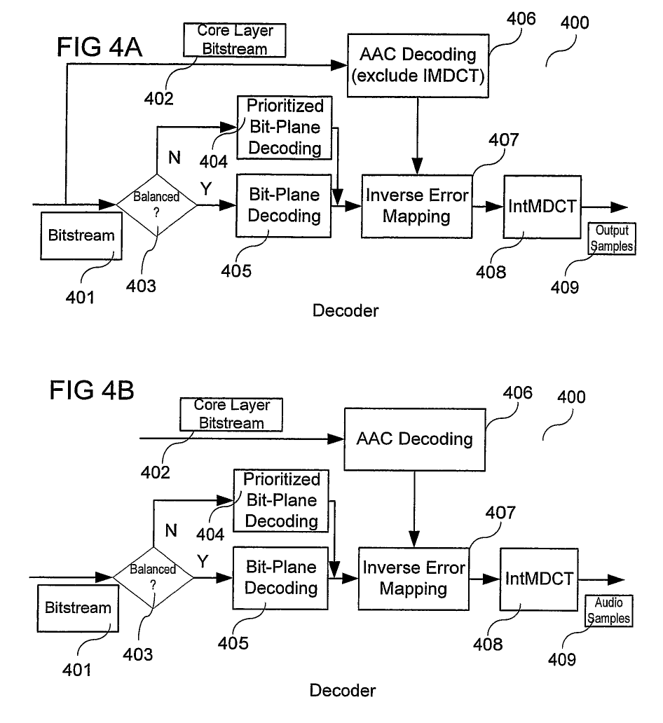

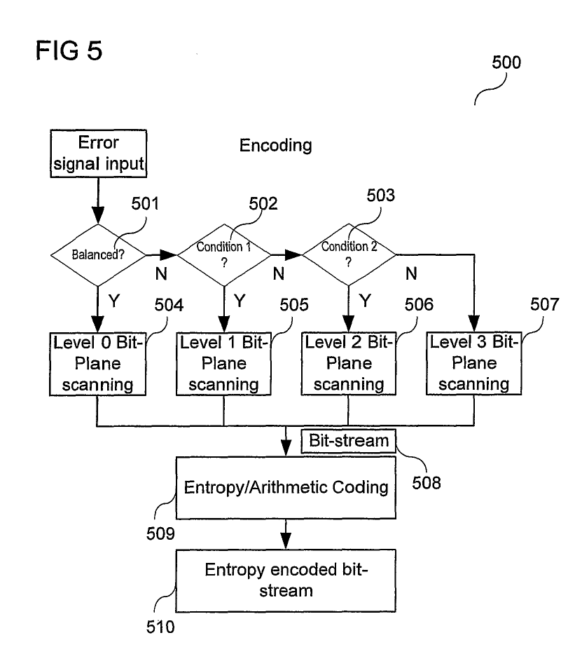

FIG. 4a and FIG. 4b each shows a decoder according to an embodiment of the invention.

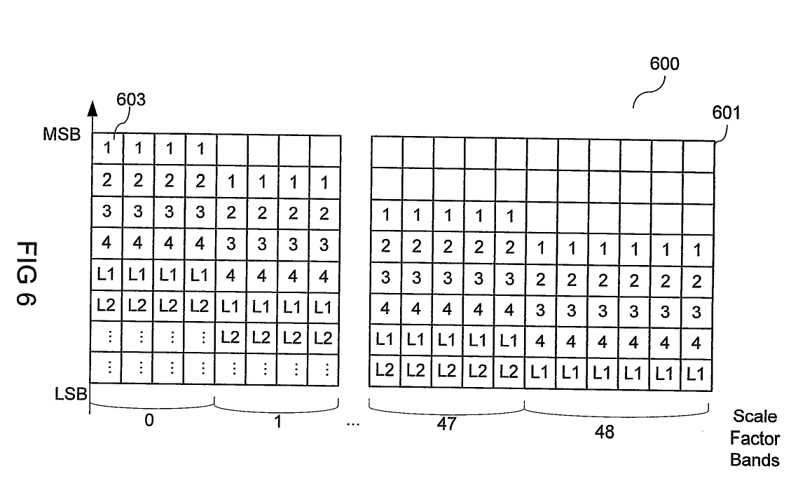

FIG. 5 shows a (bit-plane) encoder part according to an embodiment of the invention.

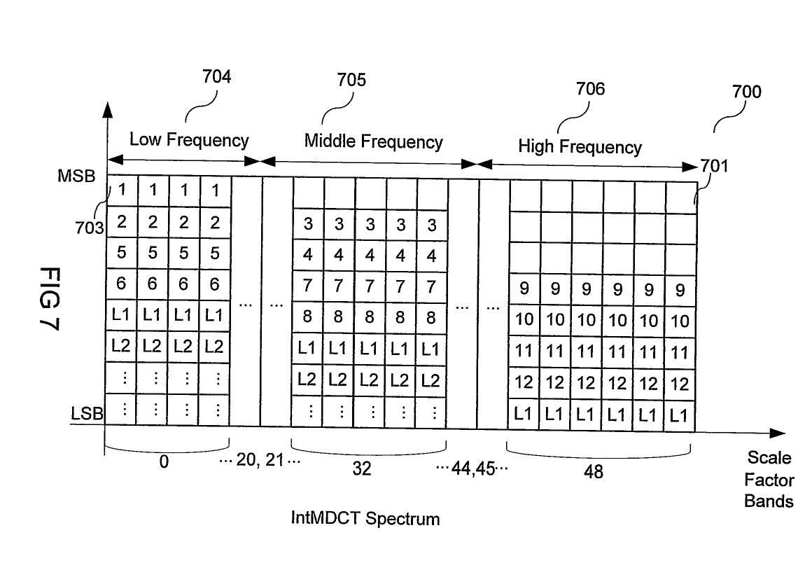

FIG. 6 shows a representation of error signal values according to an embodiment of the invention.

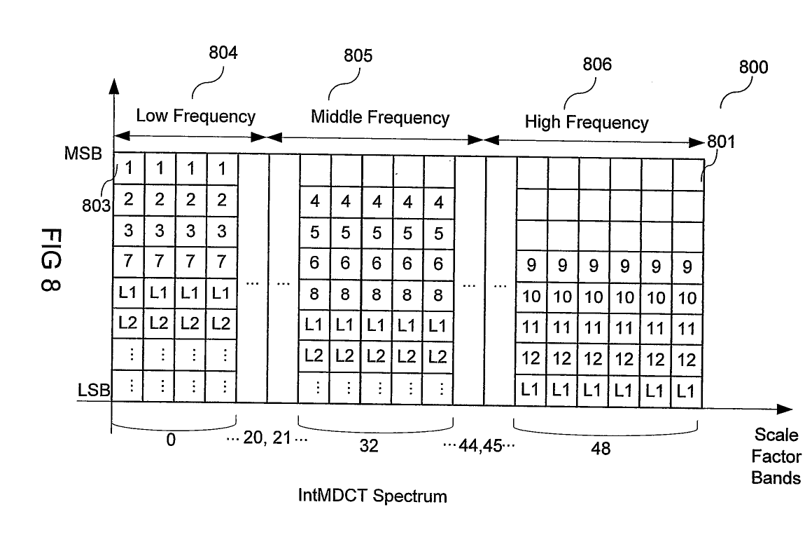

FIG. 7 shows a representation of error signal values according to an embodiment of the invention.

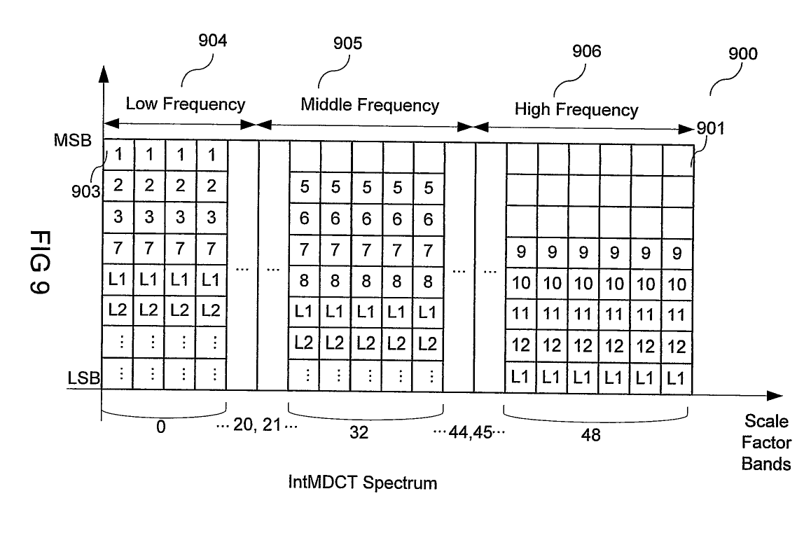

FIG. 8 shows a representation of error signal values according to an embodiment of the invention.

FIG. 9 shows a representation of error signal values according to an embodiment of the invention.

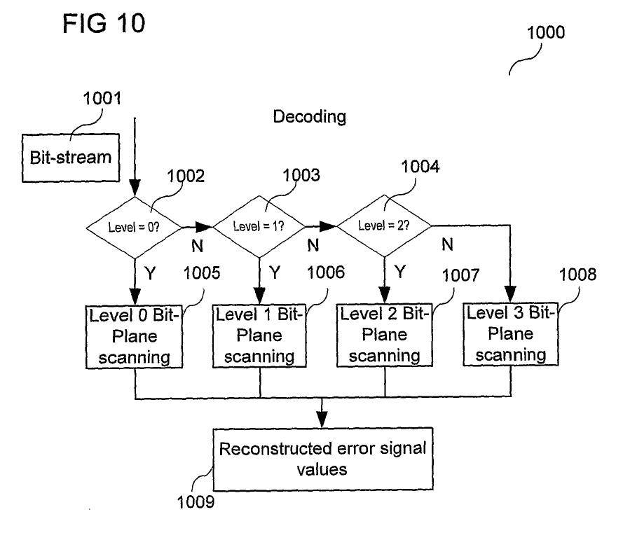

FIG. 10 shows a decoder part according to an embodiment of the invention.

FIG. 1 shows an encoder 100 according to an embodiment of the invention.

The encoder is supplied with audio data in the form of a plurality of audio samples 101, for example generated according to PCM (Pulse Coded Modulation).

The audio samples are encoded by an audio coding unit 102, for example an audio coder according to MPEG-4 AAC (Moving Pictures Expert Group 4 Advanced Audio Coding) and are also fed to an IntMDCT (Integer Modified Discrete Cosine Transform) unit 103 which performs a domain transformation of the audio samples to the frequency domain. The IntMDCT unit 103 performs a lossless transformation of the audio samples to the frequency domain.

The AAC encoding unit 102 generates frequency coefficients which correspond to the (lossy) AAC core layer. The AAC encoding unit 102 may use the output of the IntMDCT unit 103 to generate these frequency coefficients. For example, the AAC encoding unit 102 quantizes the frequency coefficients output by the IntMDCT unit 103. In one embodiment, the AAC encoding unit 102 generates a core layer according to the MPEG-4 Advanced Audio Coding (AAC) codec.

Since the output of the IntMDCT unit 103 is a lossless representation of the audio samples 101 but the output of the AAC encoding unit 102 corresponds to a lossy representation of the audio samples, the frequency coefficients generated by the AAC encoding unit 102 and the frequency coefficients generated by the IntMDCT encoding unit 103 are different. The errors of the frequency coefficients generated by the AAC encoding unit 102 with respect to the frequency coefficients generated by the IntMDCT unit 103 are calculated by an error mapping unit 104 which generates an error signal according to these errors. In this way, the error signal contains residual spectrum information.

In this embodiment, the error signal comprises a plurality of error signal values, wherein each error signal value is the difference of a frequency coefficient generated by the AAC encoding unit 102 and a frequency coefficient generated by the IntMDCT unit 103.

An example for a plurality of error signal values is shown in FIG. 2.

FIG. 2 shows a representation 200 of error signal values according to an embodiment of the invention.

The error signal values are shown in the form of a two-dimensional array 201. Each field 202 of the two-dimensional array 201 corresponds to a bit, i.e. a binary digit, of an error signal value. Each column 203 of the two-dimensional array 201 corresponds to one error signal value. This means that the fields of one column correspond to the binary digits of an error signal value, wherein the least significant bit corresponds to the field at the bottom and the significance of the bits increases in the direction of the y-axis 204.

In this example, every four frequency coefficients and accordingly, every four error signal values are grouped to a scale factor band. The number of frequency coefficients in one scale factor band is not limited to four (it may be higher or lower), and the number of frequency coefficients may increase for larger scale factor bands. The scale factor bands are shown from left to right according to their numbering, i.e. the numbers of the scale factor bands increases in the direction of the x-axis 205. Also, the frequencies to which the represented error signal values correspond increases from left to right in the direction of the x-axis. For example, the error signal value represented by the column shown rightmost is the error of the frequency coefficient generated by the AAC encoding unit 102 with respect to the frequency coefficient generated by the IntMDCT unit 103 corresponding to the highest frequency considered.

The AAC encoding unit 102 and the IntMDCT unit 103 generate frequency coefficients from blocks of the audio samples 101. This means that the audio samples 101 are grouped into blocks (frames) and from each block, the AAC encoding unit 102 and the IntMDCT unit 103 generate a plurality of frequency coefficients.

In this example, it is assumed that the ACC encoding unit 102 and the IntMDCT unit 103 each generate frequency coefficients corresponding to 49 scale factor bands which are numbered from 0 to 48. The number 48 is only chosen as example and may be different (higher and lower) in other embodiments. These frequency coefficients are generated for each block (frame). So, the process described in the following is carried out for each frame.

The encoder 100 further comprises a decision unit 105 which determines whether the error signal values are balanced. Illustratively, it is determined whether the error signal values corresponding to low frequencies are (on average) significantly lower or higher than the error signal values corresponding to high frequencies.

For this, the spectrum (of one frame) is divided into a low frequency region and a high frequency region. For example, the scale factor bands from 0 to 24 belong to the low frequency region and the scale factor bands from 25 to 48 belong to the high frequency region. Accordingly, each error signal value is associated with the low frequency region or the high frequency region, respectively, depending on to which, scale factor band it belongs.

The energy contained in the low frequency region E_{L} is calculated by the decision unit 105. This is for example done by adding the squares of all error signal values associated with the low frequency region. E_{L} may also be calculated as an average energy, for example by adding the squares of all error signal values associated with the low frequency region and dividing it by the number of error signal values associated with the low frequency region. E_{L} may also be calculated by adding the all error signal values associated with the low frequency region, i.e., without squaring. In another embodiment where core layer is absent, E_{L} is not calculated from the error signal values, but from the frequency coefficients generated by the IntMDCT unit 103.

Analogously the energy contained in the high frequency region E_{H} is calculated by the decision unit 105.

It is then decided by the decision unit 105 whether the error signal values (corresponding to the frame which is currently processed) are unbalanced, if

$$\frac{{E}_{L} - {E}_{H}}{{E}_{H}} \geq {T}_{B}$$

Otherwise, it is decided that the error signal values are balanced.

T_{B} is a threshold value. In one embodiment, T_{B} is the value of a non-increasing function of the bit-rate available for the transmission of the (encoded) audio samples, i.e.

T_{B}=f(B) with f′(B)≦0.

The function f is for example implemented in form of a codebook.

When it has been decided that the error signal values are balanced, they are encoded by a bit-plane coding unit 106. When it has been decided that the error signal values are not balanced, they are encoded by a prioritized bit-plane coding unit 107.

When it is decided that the error signal values should be encoded by the bit-plane coding unit 106, the bits of the error signal values are encoded as it is illustrated in the FIG. 2.

As mentioned above, the columns of the array 201 shown in FIG. 2 correspond to binary representations of the error signal values.

For example, an error signal value x has the binary representation

$$x = ( 2 s - 1 ) \cdot {\sum }_{j = - ∞}^{∞} {b}_{j} \cdot {2}^{j}$$

where s is a sign symbol, such that

$$s = \{ \begin{matrix}1 & if x \geq 0 \\ 0 & if x < 0\end{matrix}$$

and bⱼε{0,1} are the binary digits of x.

The bⱼ are written in the column corresponding to the error signal value x from top to bottom in the order of the most significant bit to the least significant bit.

For each scale factor band (with the number k), the bit-plane coding unit 106 determines the maximum bit-plane Mₖ for this scale factor band. The number of the maximum bit-plane Mₖ is the integer for which

2^{M}k⁻¹≦max{|xᵢ|}<2^{M}k

holds wherein the maximum is taken over all error signal values xᵢ which are associated with the scale factor band k.

The bits corresponding to the Mₖ-th digit of the error signal values associated with the scale factor band k form the Mₖ-th bit-plane of the scale factor band k.

The bit-plane coding unit 106 generates a bit-stream from the error signal values as follows. First, the maximum bit-plane of the 0th scale factor band, i.e. the M₀-th bit-plane of the scale factor band with number 0, is scanned. This means that the generated bit-stream starts with the bits of the maximum bit-plane of the first scale factor band from left to right, i.e. starting with the error signal value corresponding to the lowest frequency and proceeding in the direction of increasing frequency. Then the M₁-th bit-plane of the 1st factor band is scanned and so on until the M₄₈-th bit-plane of the 48th scale factor band. These bits are marked by ‘1’ in FIG. 2.

These bits are then followed in the bit-stream 108 by the M₀-1-th bit-plane of the scale factor band 0, the M₁-1-th bit-plane of the scale factor band 1 and so on until the M₄₈-1-th bit-plane of the scale factor band 48. These bits are marked by ‘2’ in FIG. 2.

The process continues analogously with the bits marked ‘3’ in FIG. 2 and so on. Note that in FIG. 2, the numbering after 4 continues with L1, L2 and so on. The bit-planes of the scale factor bands marked by L1, L2 and the following bit-planes are also scanned as described above but in one embodiment, the bit-stream 108 generated in this way is arithmetically coded using a probability model of the bits in the various bit-planes. The arithmetic coding is only performed for the bit-planes corresponding to the fields marked 1, 2, 3 or 4, for the other bits, a lazy mode is entered and the bits are not arithmetically coded but are left unchanged, i.e. are mapped directly to the output.

Note that the bit-stream 108 generated by scanning the bit-planes as described above may also comprise information about the signs of the error signal values and information about the maximum bit-planes, i.e., which bit-plane is the maximum bit-plane of a scale factor band.

In the encoding of the error signal values in the order illustrated in FIG. 2 the error signal values associated with the low frequency region are not treated differently from the error signal values associated with the high frequency region. When it is determined that the error signal values are not balanced, the error signal values are processed by the prioritized bit-plane coding unit 107. This means that in the bit-plane coding process the error signal values associated with the low frequency region are treated with priority. The prioritized bit-plane coding unit 107 uses a different scanning order which is illustrated in FIG. 3.

FIG. 3 shows a representation 300 of error signal values according to an embodiment of the invention.

Analogously to FIG. 2, the error signal values are shown in the form of a two-dimensional array 301 wherein each column 303 of the two-dimensional array 301 corresponds to one error signal value.

The error signal values are grouped to a low frequency region 304 that comprises the scale factor bands 0 to 24 and a high frequency region 305 that comprises the scale factor bands 25 to 48.

Analogously to the bit-plane coding unit 106, the prioritized bit-plane coding unit 107 determines for each scale factor band (with the number k), the maximum bit-plane Mₖ for this scale factor band.

Then a bit-stream is generated from the error signal values as follows. First, the maximum bit-plane of the 0th scale factor band, i.e. the M₀-th bit-plane of the scale factor band with number 0, is scanned. Then the M₁-th bit-plane of the 1st factor band is scanned and so on. In contrast to the scanning order described above with reference to FIG. 2, this is not done until the M₄₈-th bit-plane of the 48th scale factor band but only until the M₂₄-th bit-plane of the 24th scale factor band, i.e. only for all error signal values associated with the low frequency region. The bits scanned until then are marked by ‘1’ in FIG. 2.

Then, the process continues with the bits of the M₀-1-th bit-plane of the scale factor band 0, the M₁-1-th bit-plane of the scale factor band 1 and so on until the M₂₄-1-th bit-plane of the scale factor band 24. These bits are marked by ‘2’ in FIG. 2.

The process continues analogously with the bits marked ‘3’ in FIG. 3 and the bits marked ‘4’ in FIG. 3, i.e. until the M₂₄-3-th bit-plane of the scale factor band 24 has been scanned.

Then, the M₂₅-th bit-plane of the scale factor band with number 25, is scanned. Then the M₂₆-th bit-plane of the 26th factor band is scanned and so on. In this way, the error value signals of the high frequency region are now scanned similar to the error signal values of the low frequency region until the M₄₈-4-th bit-plane of the 48th factor band.

After that, the bits corresponding to the lazy planes (marked with L1 and L2 in FIG. 3) in the same order as it was explained with reference to FIG. 2. This means that for scanning the lazy planes, the low frequency region is no longer treated with higher priority than the high frequency region. However, in another embodiment of the invention, also when scanning the lazy planes, the low frequency region is treated with higher priority than the high frequency region. For example, the lazy planes of the low frequency region may be scanned first and second, the lazy planes of the high frequency region are scanned.

As mentioned above, the lazy planes differ from the “normal” bit-planes in that the parts of the generated bit-stream 108 that comprise bits from the “normal” bit-planes are arithmetically coded while the parts of the generated bit-stream 108 that comprise bits from the lazy bit-planes are not arithmetically coded. In one embodiment, the bit-plane coding unit 106 and the prioritized bit-plane coding unit 107 implement an entropy coding, such as Bit-plane Golomb Code (BPGC).

After entropy encoding the generated bit-stream 108, for example after arithmetically encoding the parts of the generated bit-stream 108 that comprise bits from the “normal” bit-planes, the bit-stream 108 is for example transmitted to a receiver. For each frame, the receiver also gets the information whether for coding the frame bit-plane coding according to the bit-plane coding unit 106 was applied or whether prioritized bit-plane coding according to the prioritized bit-plane coding unit 107 was used. In this embodiment, this information is inserted into the bit-stream 108.

In addition to the bit-stream 108, the core layer bit-stream, i.e. the output of the AAC coding unit 102 is transmitted to the receiver. This means that the bit-stream 108 and the output of the AAC coding unit 102 are transmitted together to the receiver. In one embodiment, the bit-stream 108 forms a scalable Lossless Enhancement (LLE) layer.

In the receiver, the core layer bit-stream and the entropy encoded bit-stream 108 are separated. The entropy encoded bit-stream 108 is entropy decoded and is then fed into a decoder which is explained in the following with reference to FIG. 4.

FIG. 4 shows a decoder 400 according to an embodiment of the invention.

The decoder 400 is provided with a bit-stream 401 that is to be decoded and corresponds to the bit-stream 108 shown in FIG. 1.

As mentioned above, the bit-stream 108 contains the information whether it was generated using prioritized bit-plane coding or “normal” bit-plane coding, for example in the form of one bit with the value 1 when prioritized bit-plane coding was used and the value 0 when “normal” bit-plane coding, as described with reference to FIG. 2, was used. In this way, only one bit per frame is introduced as overhead.

A decision unit 403 evaluates this information and supplies the bit-stream 401 to a prioritized bit-plane decoding unit 404 when prioritized bit-plane coding has been used and supplies the bit-stream 401 to a bit-plane decoding unit 405 when “normal” bit-plane coding has been used.

The prioritized bit-plane decoding unit 404 reconstructs the error signal values corresponding to the scanning order that is used by the prioritized bit-plane coding unit 107. This means that the prioritized bit-plane decoding unit 404 performs the inverse operation of the prioritized bit-plane coding unit 107.

Similarly, the bit-plane decoding unit 405 reconstructs the error signal values corresponding to the scanning order that is used by the bit-plane coding unit 106. This means that the bit-plane decoding unit 405 performs the inverse operation of the bit-plane coding unit 107.

Note that the bit-stream 401 may also be a truncated version of the bit-stream 108. This could be done because of low bandwidth that is available for the transmission. In this case, the error signal values generated by the prioritized bit-plane decoding unit 404 and the bit-plane decoding unit 405 are approximations of the error signal values generated by the error mapping unit 104.

The decoder 400 further receives a core layer bit-stream 402 as input that corresponds to the output of the AAC coding unit 102. From the core layer bit-stream 402 an AAC decoding unit 406 generates a plurality of frequency coefficients. For example, the AAC decoding unit 406 comprises a de-quantizer. The frequency coefficients generated by the AAC decoding unit 406 are only a lossy frequency domain representation of the audio samples 1011.e. they are not an accurate reconstruction of the frequency coefficients generated by the IntMDCT unit 103. The accuracy of the frequency coefficients generated by the AAC decoding unit 406 is enhanced by an inverse error mapping unit 407 using the error signal values generated by the prioritized bit-plane decoding unit 404 or the bit-plane decoding unit 403, respectively. This means that to each frequency coefficient generated by the AAC decoding unit 406 the corresponding error signal value is added.

The output of the inverse error mapping unit 407 is fed to an inverse IntMDCT unit 408 performing an inverse integer modified discrete cosine transform generating received audio samples 409. Depending on whether the bit-stream 401 is a truncated version of the bit-stream 108 or not, the received audio samples 409 are a lossy reconstruction or a lossless reconstruction of the audio samples 101.

In one embodiment, the switchable bit-plane coding (SBPC), i.e. the usage of prioritized bit-plane coding or “normal” bit-plane coding depending on the energy distribution as described above is used in the implementation of MPEG-4 audio Scalable Lossless Coding (SLS). The perceptual quality achieved using SLS with SBPC has been compared to the perceptual quality achieved using the original SLS for standard MPEG-4 audio test sequences. The comparison was done at various intermediate rates by using Noise to Mask Ratio (NMR) and Objective Difference Grade (ODG) measurements. Four bit-rate combinations with AAC core bit-rate at 16 and 32 kbps and a lossless enhancement bit-rate at 192 kbps have been used for testing. The results are illustrated in table 1.

| | NMR | | | ODG | | |
|---|---|---|---|---|---|---|
| | | SLS | | | SLS | |
| | | with | Improve- | | with | Improve- |
| ITEMS | SLS | SBPC | ments | SLS | SBPC | ments |

(16 + 192) kbps

| | | | | | | |
|---|---|---|---|---|---|---|
| avemaria | −3.24 | −5.95 | 2.71 | −1.83 | −1.14 | 0.69 |
| blackandtan | −2.46 | −5.50 | 3.04 | −0.81 | −0.73 | 0.08 |
| broadway | 3.58 | −1.78 | 5.36 | −2.70 | −1.76 | 0.94 |
| cherokee | −2.67 | −6.05 | 3.38 | −0.91 | −0.80 | 0.11 |
| clarinet | −3.26 | −6.18 | 2.92 | −0.91 | −0.79 | 0.12 |
| dcymbals | −0.18 | −0.77 | 0.59 | −1.63 | −1.55 | 0.08 |
| etude | −2.47 | −5.63 | 3.16 | −2.05 | −1.22 | 0.83 |
| flute | −3.23 | −6.27 | 3.04 | −2.74 | −1.95 | 0.79 |
| fouronsix | −3.90 | −7.00 | 3.10 | −0.97 | −0.86 | 0.11 |
| haffner | −2.55 | −5.74 | 3.19 | −1.12 | −0.88 | 0.24 |
| mfv | −1.98 | −4.25 | 2.28 | −2.45 | −1.58 | 0.88 |
| unfo | −3.45 | −6.05 | 2.61 | −0.83 | −0.79 | 0.05 |
| violin | −3.44 | −6.59 | 3.15 | −1.71 | −1.27 | 0.44 |
| waltz | −3.04 | −5.98 | 2.95 | −0.84 | −0.75 | 0.09 |
| Average | | | 2.96 | | | 0.39 |

(32 + 192) kbps

| | | | | | | |
|---|---|---|---|---|---|---|
| avemaria | −4.44 | −6.61 | 2.17 | −1.68 | −1.15 | 0.52 |
| blackandtan | −3.01 | −5.19 | 2.18 | −0.80 | −0.78 | 0.02 |
| broadway | 1.33 | −2.66 | 3.99 | −2.60 | −1.74 | 0.86 |
| cherokee | −3.27 | −5.69 | 2.42 | −0.92 | −0.82 | 0.11 |
| clarinet | −4.37 | −6.87 | 2.50 | −0.80 | −0.79 | 0.01 |
| dcymbals | −1.06 | −1.38 | 0.33 | −1.50 | −1.50 | 0.00 |
| etude | −3.98 | −6.34 | 2.37 | −1.89 | −1.23 | 0.66 |
| flute | −5.42 | −7.78 | 2.36 | −2.46 | −1.85 | 0.61 |
| fouronsix | −4.82 | −7.32 | 2.50 | −0.90 | −0.82 | 0.09 |
| haffner | −3.67 | −6.03 | 2.36 | −1.01 | −0.88 | 0.13 |
| mfv | −4.16 | −5.73 | 1.58 | −2.15 | −1.37 | 0.78 |
| unfo | −4.14 | −6.24 | 2.10 | −0.84 | −0.78 | 0.06 |
| violin | −4.60 | −7.34 | 2.74 | −1.45 | −1.28 | 0.17 |
| waltz | −3.63 | −5.98 | 2.34 | −0.82 | −0.75 | 0.07 |
| Average | | | 2.28 | | | 0.29 |

It can be seen from the results that for all bit-rates combinations, SLS with SBPC achieves improvements on both NMR and ODG values compared with the results of the original SLS. The improvement is very significant for some unbalanced audio sequence such as mfv.way. Moreover, the quality of different types of audio coded by the SLS with SBPC is more stable at same bit-rate. It is also worth to note that for the sequences named dcymbals.wav and haffner.wav, the improvements are marginal. The reason is that dcymbals.wav is a very balanced audio sequence and PBPC will be seldom switched on. As a result, the coding of such a sequence is almost the same as the one using the original BPC that is carried out by the bit-plane coding unit 106. While for haffner.wav, as the quantization noise for this sequence is already quite small compared with normal sequences, the improvements is marginal due to the quality saturation.

In the following, an embodiment is described according to which the error signal values are not divided into two regions (low frequency region and a high frequency region) as explained above but are divided into three regions, namely a low frequency region containing an energy E_{L}, a middle frequency region containing an energy E_{M} and a high frequency region containing an energy E_{H}.

For example, the 49 scale factor bands are grouped such that scale factor bands 0 to 20 belong to the low frequency region, scale factor bands 21 to 44 belong to the middle frequency region and scale factor bands 45 to 48 belong to the high frequency region. Also, other associations of scale factor bands with frequency regions are possible.

In this embodiment, a different encoder is used than the one shown in FIG. 1. The differences are illustrated in FIG. 5.

FIG. 5 shows a (bit-plane) encoder part 500 according to an embodiment of the invention.

The (bit-plane) encoder part 500 is in this embodiment used instead of the decision unit 105, the bit-plane coding unit 106 and the prioritized bit-plane coding unit 107. Accordingly, it is assumed that the encoder part 500 receives the error signal generated by the error mapping unit 104 as input. An encoder comprising the encoder part 500 can also be implemented without AAC Core (corresponding to SLS non core mode).

The encoder part 500 comprises a decision unit 501 into which the error signal values are fed. The decision unit 501 determines whether the error signal values are balanced.

In this embodiment, the error signal values are considered to be balanced if

$$τ = \frac{{E}_{L} - {E}_{M}}{{E}_{M}} \leq 0.$$

If the error signal values are considered to be unbalanced (i.e. not balanced) a scanning level S_{L} is selected according to

$${S}_{L} = \{ \begin{matrix}1 if & 0 < τ \leq 0.5 \\ 2 if & 0.5 \leq τ < 0.75 \\ 3 if & τ \geq 0.75\end{matrix}$$

The scanning level is set to 0 if the error signal values are balanced.

Correspondingly, if the error signal values are considered to be unbalanced, a first checking unit 502 checks whether a first condition is fulfilled. The first condition is fulfilled if τ≦0.5.

If the first condition is not fulfilled a second checking unit 503 checks whether a second condition is fulfilled. The second condition is fulfilled if τ≦0.75.

If the error signal values are considered to be balanced, a bit-stream 508 is generated from the error signal values by a first bit-plane coding unit 504.

If the error signal values are considered to be unbalanced and the first condition is fulfilled, the bit-stream 508 is generated from the error signal values by a second bit-plane coding unit 505 (this is denoted by scanning level 1).

If the error signal values are considered to be unbalanced, the first condition is not fulfilled and the second condition is fulfilled, the bit-stream 508 is generated from the error signal values by a third bit-plane coding unit 506 (this is denoted by scanning level 2).

If the error signal values are considered to be unbalanced, the first condition is not fulfilled and the second condition is not fulfilled, the bit-stream 508 is generated from the error signal values by a fourth bit-plane coding unit 507 (this is denoted by scanning level 3).

Illustratively, the bit-plane coding units 504 to 507 code the error signal values with different levels of priority of the error signal values of the low frequency region. The coding performed by the first bit-plane coding unit 504 can be considered as coding according to “normal” bit-plane scanning. The coding performed by the second bit-plane coding unit 505, the third bit-plane coding unit 506 and the fourth bit-plane coding unit 507 can be considered as coding according to “prioritized” bit-plane scanning. Thereby, the fourth bit-plane coding unit 507 can be considered as coding the error signal values of the low frequency region with highest priority and the third bit-plane coding unit 506 can be considered as coding the error signal values of the low frequency region with second highest priority.

The bit-plane coding units 504 to 507 use different bit-plane scanning orders to generate the bit-stream 508. The different bit-plane scanning orders are explained in the following with reference to the representations 600, 700, 800, 900 of error signal values shown in FIGS. 6 to 9.

In the representations 600, 700, 800, 900, similar to FIGS. 2 and 3, the bits scanned firstly according to the corresponding bit-plane scanning order are marked by ‘1’, the bits scanned secondly according to the corresponding bit-plane scanning order are marked by ‘2’, the bits scanned thirdly according to the corresponding bit-plane scanning order are marked by ‘3’, the bits scanned fourthly according to the corresponding bit-plane scanning order are marked by ‘4’. The bits marked “L1” and the bits marked “L2” are coded using a lazy mode, wherein the bits marked “L1” are scanned before the bits marked “L2” are scanned.

FIG. 6 shows a representation 600 of error signal values according to an embodiment of the invention.

Analogously to FIG. 2, the error signal values are shown in form of a two-dimensional array 601 wherein each column 603 of the two-dimensional array 601 corresponds to one error signal value.

The representation 600 illustrates the bit-plane coding order used by the first bit-plane coding unit 504.

The bit-plane scanning order is similar to the one explained with reference to FIG. 2.

First, the maximum bit-plane of the 0th scale factor band, i.e. the M₀-th bit-plane of the scale factor band with number 0, is scanned. This means that the generated bit-stream 508 starts with the bits of the maximum bit-plane of the first scale factor band from left to right, i.e. starting with the error signal value corresponding to the lowest frequency and proceeding in the direction of increasing frequency. Then the M₁-th bit-plane of the 1st factor band is scanned and so on until the M₄₈-th bit-plane of the 48th scale factor band.

These bits are then followed by the M₀-1-th bit-plane of the scale factor band 0, the M₁-1-th bit-plane of the scale factor band 1 and so on until the M₄₈-1-th bit-plane of the scale factor band 48. These bits are marked by ‘2’.

The process continues analogously with the bits marked ‘3’ in FIG. 2 and so on wherein the after 4 the scanning process continues with the bits L1, L2 and so on.

As mentioned above, this bit-plane scanning order can be considered as “normal” scanning order.

FIG. 7 shows a representation 700 of error signal values according to an embodiment of the invention.

Analogously to FIG. 2, the error signal values are shown in form of a two-dimensional array 701 wherein each column 703 of the two-dimensional array 701 corresponds to one error signal value.

As explained above, the error signal values are grouped into a low frequency region 704, a middle frequency region 705 and a high frequency region 706.

The representation 700 illustrates the bit-plane coding order used by the second bit-plane coding unit 505.

The bit-stream 508 is generated from the error signal values as follows. First, the maximum bit-plane of the 0th scale factor band, i.e. the M₀-th bit-plane of the scale factor band with number 0, is scanned. Then the M₁-th bit-plane of the 1st factor band is scanned and so on. In contrast to the scanning order described above with reference to FIG. 6, this is not done until the M₄₈-th bit-plane of the 48th scale factor band but only until the M₂₀-th bit-plane of the 20th scale factor band, i.e. only for all error signal values associated with the low frequency region (assuming that the scale factor band with the number 20 is the scale factor band with the highest number associated with the low frequency region). The bits scanned until then are marked by ‘1’ in FIG. 2.

Then, the process continues with the bits of the M₀-1-th bit-plane of the scale factor band 0, the M₁-1-th bit-plane of the scale factor band 1 and so on until the M₂₀-1-th bit-plane of the scale factor band 20. These bits are marked by ‘2’ in FIG. 7.

Then the maximum bit-plane of the 21st scale factor band, i.e. the M₂₁-th bit-plane of the scale factor band with number 21, is scanned. Then the M₂₂-th bit-plane of the 22nd factor band is scanned and so on. This is done until the M₄₄-th bit-plane of the 20th scale factor, band, i.e. for all error signal values associated with the middle frequency region (assuming that the scale factor band with the number 44 is the scale factor band with the highest number associated with the middle frequency region and that the scale factor band with the number 21 is the scale factor band with the lowest number associated with the middle frequency region). These bits are marked by ‘3’ in FIG. 7.

Then, the process continues with the bits of the M₂₁-1-th bit-plane of the scale factor band 21, the M₂₂-1-th bit-plane of the scale factor band 22 and so on until the M₄₄-1-th bit-plane of the scale factor band 44. These bits are marked by ‘4’ in FIG. 7.

Then, the scanning continues with the third most significant bits of the low frequency region and the fourth most significant bits of the low frequency region (bits marked ‘5’and ‘6’) which are scanned analogously to the bits marked ‘1’ and ‘2’.

Then, the scanning continues with the third most significant bits of the low frequency region and the fourth most significant bits of the middle frequency region (bits marked ‘7’ and ‘8’) which are scanned analogously to the bits marked ‘3’ and ‘4’.

After that, the four most significant bits of the high frequency region are scanned from left to right, i.e. the bits marked ‘9’ to ‘12’.

Finally, the bits marked ‘L1’, ‘L2’ and so on are scanned. This happens in “normal” order, i.e. starting from scale factor band 1 until scale factor band 48 for all bits marked ‘L1’ and continuing with the bit marked ‘L2’ of scale factor band 0 until the bit marked ‘L2’ of scale factor band 48 and so on.

Illustratively, according to the bit-plane scanning order shown in FIG. 7, first, the most significant bits and the second most significant bits of the low frequency region are scanned, then, the most significant bits and the second most significant bits of the middle frequency region are scanned, then, the third most significant bits and the fourth most significant bits of the low frequency region are scanned, then, the third most significant bits and the fourth most significant bits of the middle frequency region are scanned, then, the most significant bits, the second most significant bits, the third most significant bits and the fourth most significant bits of the high frequency region are scanned and finally, the remaining bits are scanned according to the “normal” order.

FIG. 8 shows a representation 800 of error signal values according to an embodiment of the invention.

Analogously to FIG. 7, the error signal values are shown in form of a two-dimensional array 801 wherein each column 803 of the two-dimensional array 801 corresponds to one error signal value.

As explained above, the error signal values are grouped into a low frequency region 804, a middle frequency region 805 and a high frequency region 806.

The representation 800 illustrates the bit-plane coding order used by the third bit-plane coding unit 506.

The bit-plane scanning order differs from the one explained with reference to FIG. 7 in that the third most significant bits of the low frequency region (marked ‘3’) are scanned before the most significant bits of the middle frequency region (marked ‘4’).

This can be seen as further prioritizing the error signal values of the low frequency region with respect to the error signal values of the middle frequency region compared to the bit-plane scanning or explained with reference to FIG. 7.

FIG. 9 shows a representation 900 of error signal values according to an embodiment of the invention.

Analogously to FIG. 7, the error signal values are shown in form of a two-dimensional array 901 wherein each column 903 of the two-dimensional array 901 corresponds to one error signal value.

As explained above, the error signal values are grouped into a low frequency region 904, a middle frequency region 905 and a high frequency region 906.

The representation 900 illustrates the bit-plane coding order used by the fourth bit-plane coding unit 906.

The bit-plane scanning order differs from the one explained with reference to FIG. 8 in that even the fourth most significant bits of the low frequency region (marked ‘4’) are scanned before the most significant bits of the middle frequency region (marked ‘5’).

This can be seen as further prioritizing the error signal values of the low frequency region with respect to the error signal values of the middle frequency region compared to the bit-plane scanning or explained with reference to FIG. 8.

The bit-stream 508 is entropy encoded, for example according to an arithmetic coding scheme, by an entropy coding unit 509 generating an entropy encoded bit-stream 510.

In the entropy encoded bit-stream 510 the information is contained which bit-plane scanning order was used, that is which bit-plane coding unit 504 to 507 generated the bit-stream 508. This is done for every block (frame) of the audio signal 101. Therefore, two bits per frame have to be transmitted per frame. In one embodiment, the encoder is implemented based on SLS. In this case, one reserved bit per frame can be used and one extra bit per frame has to be used. The complexity is only increased by one computation of the value τ per frame.

An decoder part corresponding to the encoder part 500 is described in the following.

FIG. 10 shows a decoder part 1000 according to an embodiment of the invention.

The decoder part 1000 corresponds to the encoder part 500 shown in FIG. 5. It is used in a decoder similar to the decoder 400 shown in FIG. 4 instead of the decision unit 403, the prioritized bit-plane decoding unit 404 and the bit-plane decoding unit 405.

The decoder part 1000 is supplied with a bit-stream 1001 that is to be decoded and corresponds to the bit-stream 508 shown in FIG. 5. The decoder part 1000 is further supplied with the information (which is contained in the entropy encoded bit-stream 510 as mentioned above) which bit-plane scanning order was used for generating the bit-stream 1001, that is which bit-plane coding unit 504 to 507 generated the bit-stream 508.

For example, two information bits per frame have to be transmitted to the decoder comprising the decoder part 1000 to specify the bit-plane scanning level/scanning order. For example, scanning level 0 is indicated by bits 00, scanning level 1 is indicated by bits 01, scanning level 2 is indicated by Bits 10 and scanning level 3 is indicated by Bits 11. The corresponding scanning level for a frame is selected based on the transmitted two bits for that frame.

This information is evaluated by a first checking unit 1002, a second checking unit 1003 and a third checking unit 1004.

The first checking unit 1002 determines whether the bit-stream 1001 was generated by the first bit-plane coding unit 504. If this is the case, the bit-stream 1001 is decoded by a first bit-plane decoding unit 1005 corresponding to the first bit-plane coding unit 504.

If the first checking unit 1002 determines that the bit-stream 1001 was not generated by the first bit-plane coding unit 504, the second checking unit 1003 determines whether the bit-stream 1001 was generated by the second bit-plane coding unit 505. If this is the case, the bit-stream 1001 is decoded by a second bit-plane decoding unit 1006 corresponding to the second bit-plane coding unit 505.

If the second checking unit 1003 determines that the bit-stream 1001 was not generated by the second bit-plane coding unit 505, the third checking unit 1004 determines whether the bit-stream 1001 was generated by the third bit-plane coding unit 506. If this is the case, the bit-stream 1001 is decoded by a third bit-plane decoding unit 1007 corresponding to the third bit-plane coding unit 506.

If the third checking unit 1002 determines that the bit-stream 1001 was not generated by the third bit-plane coding unit 506, the bit-stream 1001 is decoded by a fourth bit-plane decoding unit 1006 corresponding to the fourth bit-plane coding unit 507.

Each bit-plane decoding unit 1005 to 1008 reconstructs the error signal values corresponding to the scanning order that is used by the corresponding bit-plane coding unit 504 to 507. This means that the bit-plane decoding unit 1005 to 1008 performs the inverse operation of the corresponding bit-plane coding unit 504 to 507.

Note that the bit-stream 1001 may also be a truncated version of the bit-stream 508. This could be done because of low bandwidth that is available for the transmission. In this case, the reconstructed error signal values 1009 generated by the bit-plane decoding units 1005 to 1008 are approximations of the error signal values generated by the error mapping unit 104.

The bit-stream 1001 is for example generated from the (possibly truncated) entropy encoded bit-stream 510 by an entropy decoding unit (not shown) corresponding to the entropy coding unit 509 (i.e. performing the inverse operation thereof). In one embodiment, the entropy decoding is performed after the processing of the entropy encoded bit-stream by the bit decoding units 1005 to 1008.

The encoding scheme according to the embodiment described with reference to FIGS. 5 to 10 is for example denoted by Quad-level Bit-Plane Coding (QBPC). It may for example be implemented in the non-core mode of MPEG-4 SLS reference model source code. As shown in FIGS. 1 and 4, the corresponding encoder and decoder may contain an IntMDCT filterbank and a bit-plane coding block. For example, the IntMDCT spectrum is coded using Bit-Plane Golomb Code (BPGC) to generate a scalable bit-stream. With respect to SLS, the bit-plane coding of SLS is replaced by a QBPC block in the encoder and the decoder as explained above.

The perceptual quality of the non-core SLS with QBPC was compared with that of the original SLS at various intermediate rates by using Objective Difference Grade (ODG) measurements. In the evaluation, the standard MPEG-4 audio test sequences have been used, which include 15 stereo music files sampled at 48 kHz, 16 bits/sample. The results are illustrated in the following table, where six intermediate bitrates including 96, 128, 160, 192, 224 and 256 kbps are used for testing.

| | ODG | | |
|---|---|---|---|
| | | Non-core | |
| | Non-core | SLS with | |
| ITEMS | SLS | QBPC | Improvements |

96 kbps

| | | | |
|---|---|---|---|
| avemaria | −3.31 | −2.37 | 0.94 |
| blackandtan | −2.64 | −1.95 | 0.69 |
| broadway | −3.69 | −2.44 | 1.24 |
| cherokee | −2.72 | −2.03 | 0.70 |
| clarinet | −2.75 | −2.11 | 0.64 |
| cymbal | −3.52 | −3.37 | 0.15 |
| dcymbals | −3.35 | −3.32 | 0.03 |
| etude | −3.44 | −2.38 | 1.06 |
| flute | −3.62 | −2.28 | 1.34 |
| fouronsix | −2.88 | −2.32 | 0.56 |
| haffner | −3.25 | −2.34 | 0.92 |
| mfv | −3.09 | −1.77 | 1.32 |
| unfo | −2.87 | −2.43 | 0.44 |
| violin | −3.41 | −2.32 | 1.09 |
| waltz | −2.75 | −2.16 | 0.60 |
| Average | −3.15 | −2.37 | 0.78 |

128 kbps

| | | | |
|---|---|---|---|
| avemaria | −2.62 | −1.41 | 1.21 |
| blackandtan | −1.56 | −1.01 | 0.55 |
| broadway | −3.39 | −1.49 | 1.91 |
| cherokee | −1.67 | −1.14 | 0.53 |
| clarinet | −1.61 | −1.16 | 0.45 |
| cymbal | −3.14 | −2.91 | 0.23 |
| dcymbals | −2.33 | −2.33 | 0.00 |
| etude | −2.92 | −1.41 | 1.51 |
| flute | −3.30 | −1.45 | 1.85 |
| fouronsix | −1.85 | −1.42 | 0.43 |
| haffner | −2.20 | −1.24 | 0.96 |
| mfv | −2.92 | −0.87 | 2.06 |
| unfo | −1.73 | −1.35 | 0.38 |
| violin | −2.65 | −1.38 | 1.28 |
| waltz | −1.63 | −1.16 | 0.46 |
| Average | −2.37 | −1.45 | 0.92 |

160 kbps

| | | | |
|---|---|---|---|
| avemaria | −2.15 | −1.01 | 1.13 |
| blackandtan | −0.99 | −0.63 | 0.36 |
| broadway | −3.02 | −1.03 | 1.99 |
| cherokee | −1.05 | −0.67 | 0.38 |
| clarinet | −1.17 | −0.89 | 0.28 |
| cymbal | −2.86 | −2.39 | 0.47 |
| dcymbals | −1.91 | −1.95 | −0.05 |
| etude | −2.41 | −1.00 | 1.41 |
| flute | −3.12 | −1.07 | 2.06 |
| fouronsix | −1.19 | −0.88 | 0.31 |
| haffner | −1.58 | −0.85 | 0.72 |
| mfv | −2.77 | −0.82 | 1.95 |
| unfo | −1.16 | −0.89 | 0.27 |
| violin | −2.29 | −1.02 | 1.27 |
| waltz | −1.06 | −0.72 | 0.35 |
| Average | −1.91 | −1.06 | 0.86 |

192 kbps

| | | | |
|---|---|---|---|
| avemaria | −1.68 | −0.70 | 0.98 |
| blackandtan | −0.84 | −0.53 | 0.31 |
| broadway | −2.80 | −0.75 | 2.04 |
| cherokee | −0.92 | −0.56 | 0.36 |
| clarinet | −0.90 | −0.63 | 0.27 |
| cymbal | −2.55 | −1.92 | 0.63 |
| dcymbals | −1.70 | −1.56 | 0.14 |
| etude | −2.00 | −0.66 | 1.34 |
| flute | −2.58 | −0.61 | 1.96 |
| fouronsix | −0.91 | −0.66 | 0.25 |
| haffner | −1.26 | −0.61 | 0.65 |
| mfv | −1.96 | −0.89 | 1.07 |
| unfo | −0.82 | −0.62 | 0.20 |
| violin | −1.69 | −0.67 | 1.01 |
| waltz | −0.83 | −0.55 | 0.28 |
| Average | −1.56 | −0.80 | 0.77 |

224 kbps

| | | | |
|---|---|---|---|
| avemaria | −1.01 | −0.51 | 0.50 |
| blackandtan | −0.57 | −0.45 | 0.12 |
| broadway | −2.13 | −0.62 | 1.51 |
| cherokee | −0.61 | −0.49 | 0.12 |
| clarinet | −0.55 | −0.46 | 0.10 |
| cymbal | −2.22 | −1.68 | 0.54 |
| dcymbals | −1.04 | −1.04 | 0.00 |
| etude | −1.23 | −0.49 | 0.75 |
| flute | −1.81 | −0.43 | 1.38 |
| fouronsix | −0.60 | −0.52 | 0.08 |
| haffner | −0.72 | −0.44 | 0.28 |
| mfv | −1.50 | −1.09 | 0.41 |
| unfo | −0.58 | −0.48 | 0.09 |
| violin | −1.05 | −0.49 | 0.56 |
| waltz | −0.57 | −0.45 | 0.12 |
| Average | −1.08 | −0.64 | 0.44 |

256 kbps

| | | | |
|---|---|---|---|
| avemaria | −0.73 | −0.44 | 0.29 |
| blackandtan | −0.41 | −0.38 | 0.03 |
| broadway | −1.62 | −0.47 | 1.15 |
| cherokee | −0.43 | −0.42 | 0.01 |
| clarinet | −0.46 | −0.40 | 0.05 |
| cymbal | −1.74 | −1.44 | 0.29 |
| dcymbals | −0.75 | −0.82 | −0.07 |
| etude | −0.91 | −0.41 | 0.50 |
| flute | −1.48 | −0.37 | 1.11 |
| fouronsix | −0.44 | −0.44 | 0.00 |
| haffner | −0.56 | −0.39 | 0.18 |
| mfv | −1.35 | −0.99 | 0.36 |
| unfo | −0.44 | −0.42 | 0.02 |
| violin | −0.85 | −0.42 | 0.43 |
| waltz | −0.44 | −0.39 | 0.05 |
| Average | −0.84 | −0.55 | 0.29 |

From these results, it can be observed that for all these bitrates, non-core SLS with QBPC achieves improvements on the ODG values compared with the results of the original non-core SLS. The improvement is very significant for most of the sequences. In addition, the quality of different types of audio coded by the non-core SLS with QBPC is more stable at same bitrate. It is also worth to note that for the sequence named dcymbals.wav, the improvements are marginal. The reason is that this sequence is very balanced in energy distribution, resulting QBPC always stays at Level 0 bit-plane scanning (i.e. the bit-stream 508 is generated by the first bit-plane coding unit 504 for most frames). As a result, the coding of such a sequence is almost the same as the one using the SLS bit-plane coding.

It is also observed that the improvements at high bitrates are relatively small. This is reasonable since the prioritization of bit-planes has no impacts when the bitrate is enough for all the non-Lazy bit-planes to be coded.

From the results, one can see that by switching the bit-plane scanning orders according to the energy distribution of the audio signal in the frequency spectrum, bit-plane coding is performed in a more efficient manner.

The simulation results verify that the perceptual quality of audio at intermediate bitrates is improved by a significant amount in terms of ODG measurement using the invention comparing with the original non-core SLS for most of audio sequences. Meanwhile, this is achieved with introducing negligible overhead in terms of computational complexity or lossless coding efficiency.

1. A method for encoding a plurality of signal values, wherein
the signal values are grouped into a first subgroup and a second subgroup,
the signal values of the first subgroup are compared to the signal values of the second subgroup,
based on the result of the comparison it is decided whether the signal values of the first subgroup should be encoded with higher priority than the signal values of the second subgroup,
the signal values of the first subgroup and the signal values of the second subgroup are bit-plane coded wherein the signal values of the first subgroup are bit-plane coded with priority if it is decided that the signal values of the first subgroup should be encoded with higher priority than the signal values of the second subgroup.

2. The method according to claim 1, wherein each signal value corresponds to a frequency.

3. The method according to claim 2, wherein the first subgroup comprises all signal values corresponding to frequencies of a first frequency region and the second subgroup comprises all signal values corresponding to frequencies of a second frequency region.

4. The method according to claim 3, wherein the frequencies of the first frequency region are lower than the frequencies of the second frequency region.

5. The method according to claim 2, wherein each signal value is an error signal value specifying an error between a first frequency coefficient and a second frequency coefficient for the frequency the signal value corresponds to.

6. The method according to the claim 5, wherein the first frequency coefficient corresponds to a lossy frequency domain representation of a data signal and the second frequency coefficient corresponds to a lossless frequency domain representation of the data signal.

7. The method according to claim 1, wherein, if it is decided that the signal values of the first subgroup should be encoded with higher priority than the signal values of the second subgroup, the signal values of the first subgroup are at least partially bit-plane coded before the signal values of the second subgroup are bit-plane coded.

8. The method according to claim 7, wherein, if it is decided that the signal values of the first subgroup should not be encoded with higher priority than the signal values of the second subgroup the signal values of the first subgroup and the signal values of the second subgroup are bit-plane coded with same priority.

9. The method according to claim 1, wherein a comparison value is determined based on the comparison of the signal values of the first subgroup to the signal values of the second subgroup and wherein based on the size of the comparison value the priority level with which the signal values of the first subgroup should be encoded is determined.

10. The method according to claim 9, wherein a plurality of value ranges are predetermined, each value range is associated with a priority level and the priority level with which the signal values of the first subgroup should be encoded is determined as the priority level associated with the value range in which the comparison value is located.

11. The method according to claim 9, wherein the comparison value is calculated based on an energy measure of the signal values of the first subgroup and the second subgroup.

12. The method according to claim 1, wherein the first subgroup comprises all signal values corresponding to frequencies of a first frequency region and the second subgroup comprises all signal values corresponding to frequencies of a second frequency region and a third frequency region, wherein the frequencies of the first frequency region are lower than the frequencies of the second frequency region and the frequencies of the second frequency region are lower than the frequencies of the third frequency region and, when it is decided that the signal values of the first subgroup should be encoded with higher priority than the signal values of the second subgroup, the signal values corresponding to frequencies of the second frequency region are also encoded with higher priority than the signal values corresponding to frequencies of the third frequency region.

13. Encoder for encoding a plurality of signal values, comprising
a grouping unit grouping the signal values into a first subgroup and a second subgroup
a comparing unit comparing the signal values of the first subgroup to the signal values of the second subgroup
a deciding unit deciding based on the result of the comparison whether the signal values of the first subgroup should be encoded with higher priority than the signal values of the second subgroup
a bit-plane coding unit bit-plane coding the signal values of the first subgroup and the signal values of the second subgroup wherein the signal values of the first subgroup are bit-plane coded with priority if it is decided that the signal values of the first subgroup should be encoded with higher priority than the signal values of the second subgroup.

14. A computer program product, which, when executed by a computer, makes the computer perform a method for encoding a plurality of signal values, wherein
the signal values are grouped into a first subgroup and a second subgroup
the signal values of the first subgroup are compared to the signal values of the second subgroup
based on the result of the comparison it is decided whether the signal values of the first subgroup should be encoded with higher priority than the signal values of the second subgroup
the signal values of the first subgroup and the signal values of the second subgroup are bit-plane coded wherein the signal values of the first subgroup are bit-plane coded with priority if it is decided that the signal values of the first subgroup should be encoded with higher priority than the signal values of the second subgroup.

15. A method for decoding a plurality of encoded signal values, comprising
receiving the encoded signal values being bit-plane coded from a plurality of signal values, the signal values being grouped to a first subgroup and a second subgroup,
determining whether the signal values of the first subgroup have been bit-plane coded with priority when the signal values have been encoded,
bit-plane decoding the encoded signal values taking into account whether the signal values of the first subgroup have been bit-plane coded with priority when the signal values have been encoded.

16. A decoder for decoding a plurality of encoded signal values, comprising
a receiver receiving the encoded signal values being bit-plane coded from a plurality of signal values, the signal values being grouped to a first subgroup and a second subgroup,
a determining unit determining whether the signal values of the first subgroup have been bit-plane coded with priority when the signal values have been encoded,
a bit-plane decoding unit bit-plane decoding the encoded signal values taking into account whether the signal values of the first subgroup have been bit-plane coded with priority when the signal values have been encoded.

17. A computer program product, which, when executed by a computer, makes the computer perform a method for decoding a plurality of encoded signal values,
receiving the encoded signal values being bit-plane coded from a plurality of signal values, the signal values being grouped to a first subgroup and a second subgroup,
determining whether the signal values of the first subgroup have been bit-plane coded with priority when the signal values have been encoded,
bit-plane decoding the encoded signal values taking into account whether the signal values of the first subgroup have been bit-plane coded with priority when the signal values have been encoded.
